(19) United States
(12) Patent Application Publication
(10) Pub. No.: US 2025/0183774 A1
(43) Pub. Date: Jun. 5, 2025

(54) VIBRATION GENERATING DEVICE

(71) Applicant: ALPS ALPINE CO., LTD., Tokyo (JP)

(72) Inventors: Takayuki SUIZU, Miyagi (JP); Ryota SUZUKI, Miyagi (JP)

(21) Appl. No.: 19/037,917

(22) Filed: Jan. 27, 2025

Related U.S. Application Data
(63) Continuation of application No. PCT/JP2023/008909, filed on Mar. 8, 2023.

(30) Foreign Application Priority Data
Aug. 2, 2022 (JP) 2022-123572

(51) Int. Cl. H02K 33/18

(52) U.S. Cl. CPC H02K 33/18

(57) ABSTRACT

A vibration generating device includes a housing; a movable body housed in the housing; a supporting member configured to support the movable body to be vibratable along a first direction; a coil including a wire bundle that extends along a second direction perpendicular to the first direction; and a magnetic flux generating member configured to generate a magnetic flux that passes through the wire bundle along a third direction perpendicular to each of the first direction and the second direction.

### CROSS-REFERENCE TO RELATED APPLICATIONS

This application is a continuation application of International Application No. PCT/JP2023/008909, filed on Mar. 8, 2023, and designated the U.S., which is based upon and claims priority to Japanese Patent Application No. 2022-123572, filed on Aug. 2, 2022, the entire contents of which are incorporated herein by reference.

### BACKGROUND

### 1. Field of the Invention

The present disclosure relates to a vibration generating device.

### 2. Description of the Related Art

An actuator (vibration generating device) configured to generate a vibration is known (see Japanese Laid-Open Patent Application No. 2019-013086). This actuator is configured to vibrate a movable body relative to a support by a magnetic drive circuit including a coil and a magnet. Also, this actuator is configured to suppress resonance of the movable body by using a viscoelastic member that is a gel-like damper member disposed between the support and the movable body.

### SUMMARY

A vibration generating device according to an embodiment of the present disclosure includes: a housing; a movable body housed in the housing; a supporting member configured to support the movable body to be vibratable along a first direction; a coil including a wire bundle that extends along a second direction perpendicular to the first direction; and a magnetic flux generating member configured to generate a magnetic flux that passes through the wire bundle along a third direction perpendicular to each of the first direction and the second direction. One of the coil or the magnetic flux generating member is fixed to the housing. Another of the coil or the magnetic flux generating member is fixed to the movable body. The vibration generating device includes a conductive member that is fixed to the coil and extends along the first direction so as to cross the magnetic flux, and is configured to reduce an acceleration of the movable body by generating an eddy current in response to a movement of the movable body along the first direction.

### BRIEF DESCRIPTION OF THE DRAWINGS

FIG. 1 is a perspective view of a vibration generating device;

FIG. 2 is an exploded perspective view of the vibration generating device;

FIG. 3 is an exploded perspective view of a vibrating portion and a non-vibrating body;

FIG. 4 is a perspective view of the non-vibrating body;

FIG. 5 is a view illustrating a configuration example of a base member and an elastic supporting member;

FIG. 6 is a perspective view of the vibrating portion;

FIG. 7 is a perspective view of components of a driver;

FIG. 8 is a perspective view of a leaf spring;

FIG. 9 is a perspective view of the base member and a bracket;

FIG. 10 is a cross-sectional view of a vibrating body;

FIG. 11 is a perspective view of members forming the vibration generating device;

FIG. 12 is a perspective view of the members forming the vibration generating device; and

FIG. 13 is a graph indicating a relationship between a drive frequency and a vibration acceleration of the vibrating body.

### DETAILED DESCRIPTION OF THE DISCLOSURE

The above-described viscoelastic member may have a concern about durability.

Therefore, it is desirable to provide a more durable vibration generating device.

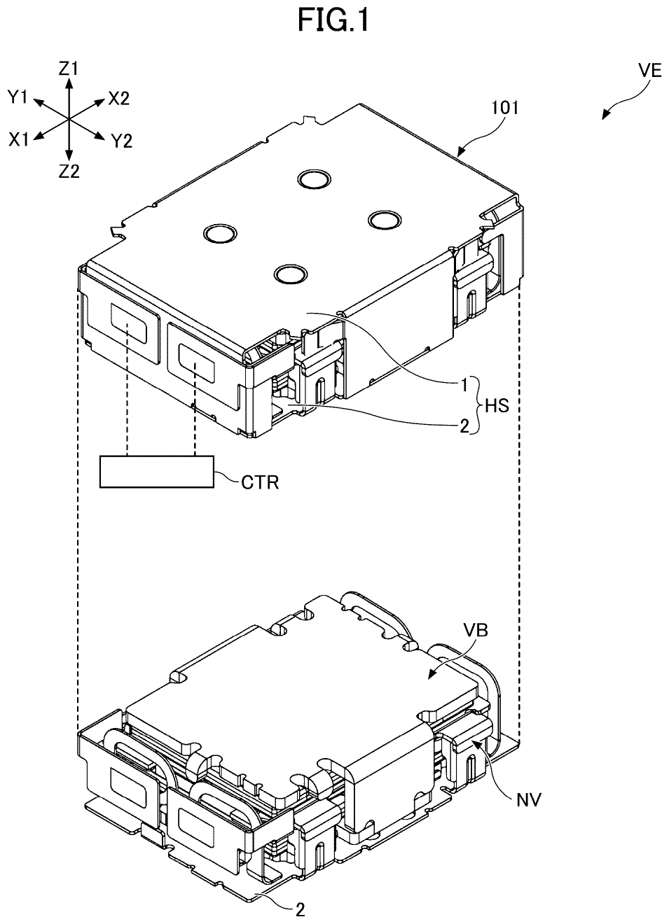

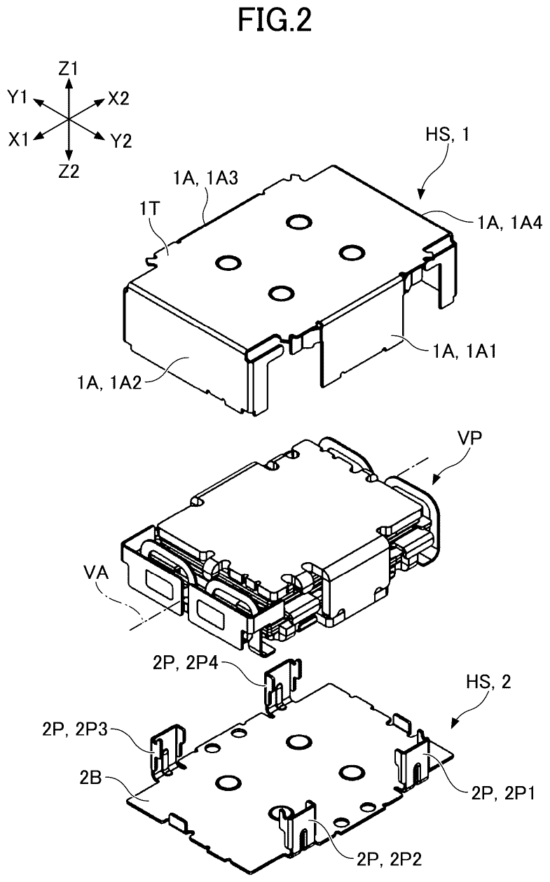

Hereinafter, a vibrating device VE including a vibration generating device 101 according to an embodiment of the present disclosure will be described with reference to the drawings. FIG. 1 is a perspective view of the vibrating device VE including the vibration generating device 101 and a controller CTR. Specifically, the upper view of FIG. 1 is a perspective view of the vibration generating device 101 connected to the controller CTR, and the lower view of FIG. 1 is a perspective view of the vibration generating device 101 in a state in which a cover member 1 is removed. FIG. 2 is an exploded perspective view of the vibration generating device 101.

In each of FIGS. 1 and 2, X1 represents one direction of an X axis that forms a three-dimensional orthogonal coordinate system, and X2 represents the other direction of the X axis. Also, Y1 represents one direction of a Y axis that forms the three-dimensional orthogonal coordinate system, and Y2 represents the other direction of the Y axis. Similarly, Z1 represents one direction of a Z axis that forms the three-dimensional orthogonal coordinate system, and Z2 represents the other direction of the Z axis. In the present embodiment, an X1 side of the vibration generating device 101 corresponds to a front side (front-face side) of the vibration generating device 101, and an X2 side of the vibration generating device 101 corresponds to a rear side (rear-face side) of the vibration generating device 101. Also, a Y1 side of the vibration generating device 101 corresponds to a left side of the vibration generating device 101, and a Y2 side of the vibration generating device 101 corresponds to a right side of the vibration generating device 101. A Z1 side of the vibration generating device 101 corresponds to an upper side of the vibration generating device 101, and a Z2 side of the vibration generating device 101 corresponds to a lower side of the vibration generating device 101. The same applies to the other drawings.

The vibrating device VE includes the controller CTR and the vibration generating device 101. The vibration generating device 101 includes a housing HS and a vibrating portion VP housed in the housing HS.

As illustrated in FIG. 1, the housing HS has a substantially rectangular parallelepiped outer shape. In the present embodiment, the housing HS is formed of a non-magnetic material, such as austenitic stainless steel or the like. The housing HS is formed by the cover member 1 and a base member 2.

As illustrated in FIG. 2, the cover member 1 is configured to form the side and top surfaces of the housing HS, and the base member 2 is configured to form the bottom surface of the housing HS. In the illustrated example, the base member 2 is configured to function as a base configured to support the vibrating portion VP.

In the present embodiment, the cover member 1 includes an outer peripheral wall 1A having a substantially rectangular cylindrical shape, and a top plate 1T that has a flat plate shape and is provided so as to be continuous with the top end (Z1-side end) of the outer peripheral wall 1A.

The outer peripheral wall 1A includes four side plates each formed in a flat plate shape. Specifically, as illustrated in FIG. 2, the outer peripheral wall 1A includes a first side plate 1A1 and a third side plate 1A3 that face each other, and a second side plate 1A2 and a fourth side plate 1A4 that face each other and are perpendicular to the first side plate 1A1 and the third side plate 1A3, respectively.

The controller CTR is configured to achieve a movement of the vibrating portion VP. In the present embodiment, the controller CTR includes an electronic circuit, and is configured to supply, to the vibrating portion VP, an alternating current for vibrating the vibrating portion VP. In the present embodiment, the controller CTR is disposed outside the housing HS, but may be disposed inside the housing HS. In this case, the controller CTR may be one of the components of the vibration generating device 101.

The vibrating portion VP is configured to vibrate the housing HS by its own vibration. In the present embodiment, the vibrating portion VP is configured to vibrate the housing HS with the vibrating portion VP being attached inside the housing HS.

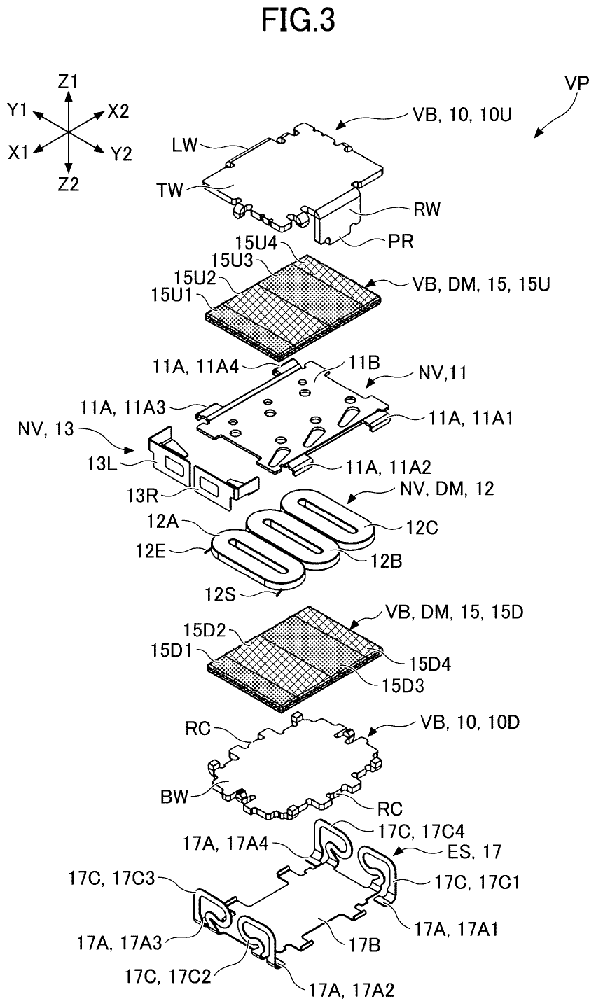

Next, details of the vibrating portion VP will be described with reference to FIG. 3. FIG. 3 is an exploded perspective view of the vibrating portion VP. The vibrating portion VP includes a vibrating body VB, a driver DM, and an elastic supporting member ES.

The vibrating body VB, which is the movable body, has a predetermined natural frequency and is configured to be vibratable with respect to the housing HS along a vibration axis VA (see FIG. 2) extending in a predetermined direction. In the present embodiment, the vibrating body VB has a predetermined natural frequency and is configured to be vibratable with respect to the base member 2 along the vibration axis VA (see FIG. 2) extending in an X-axis direction (front-rear direction).

The driver DM is an example of a vibrating force generator and is configured to vibrate the vibrating body VB along the vibration axis VA. In the present embodiment, the driver DM is configured to vibrate the vibrating body VB, elastically supported by the elastic supporting member ES, along the vibration axis VA, in response to an alternating current supplied through the controller CTR.

The elastic supporting member ES is an example of the supporting member and is configured to elastically support the vibrating body VB with the elastic supporting member ES being between the housing HS and the vibrating body VB.

Specifically, the vibrating portion VP, including the vibrating body VB, the driver DM, and the elastic supporting member ES, is formed by a yoke 10, a bracket 11, a coil 12, a wiring board 13, a magnet 15, and a leaf spring 17. The vibrating body VB is formed by the yoke 10 and the magnet 15, the driver DM is formed by the coil 12 and the magnet 15, and the elastic supporting member ES is formed by the leaf spring 17. The bracket 11, the coil 12, and the wiring board 13 form a non-vibrating body NV configured not to vibrate along with the vibrating body VB. The non-vibrating body NV vibrates along with the housing HS, but does not vibrate along with the vibrating body VB.

The yoke 10 is a member forming a magnetic circuit. In an embodiment, the yoke 10 is formed of a magnetic material, including iron or the like. In the illustrated example, the yoke 10 is formed by two members, i.e., an upper yoke 10U and a lower yoke 10D, and is formed by steel plate cold commercial (SPCC). The upper yoke 10U is a member forming the top surface of the vibrating body VB, and includes a left side plate LW, a right side plate RW, and a top plate TW. Specifically, projecting portions PR are formed at 22-side end surfaces of the left side plate LW and the right side plate RW so as to be engageable with recessed portions RC formed in the lower yoke 10D. The lower yoke 10D is a member forming the bottom surface of the vibrating body VB, and includes a bottom plate BW. Specifically, the recessed portions RC are formed at a Y1-side (left side) end surface and a Y2-side (right side) end surface of the lower yoke 10D so as to be engageable with the projecting portions PR formed at the upper yoke 10U.

The bracket 11 is an example of the conductive member and is configured to support the coil 12 in a state in which the coil 12 is caused to face the magnet 15 in a non-contact manner. That is, the bracket 11 is configured to function as a coil holder configured to support the coil 12. The bracket 11 is fixed to the base member 2 so as not to contact the vibrating body VB. In the present embodiment, the bracket 11 is a plate-like member formed of a non-magnetic material, such as copper, aluminum, or an alloy thereof, and includes connecting portions 11A and a plate-like portion 11B. Specifically, the bracket 11 is fixed to the base member 2 by means of a fastening member, welding, bonding, or caulking via four connecting portions 11A each projecting outward of the plate-like portion 11B at a position at which the bracket 11 and the coil 12 do not contact the vibrating body VB even if the vibrating body VB vibrates. That is, the bracket 11, to which the coil 12 is to be attached, is configured so as not to vibrate along with the vibrating body VB.

The coil 12 is configured to generate a magnetic field by receiving supply of a current. In the example illustrated in FIG. 3, the coil 12 includes three coil-wound portions connected in series (a first coil-wound portion 12A, a second coil-wound portion 12B, and a third coil-wound portion 12C). Each of the first coil-wound portion 12A, the second coil-wound portion 12B, and the third coil-wound portion 12C has a substantially elliptical shape (a rectangle shape having round corners) having a major axis along a Y-axis direction. The coil 12 includes a first end 12S at which winding starts, and a second end 12E at which winding ends. The coil 12 is fixed to a Z2-side (lower) surface of the bracket 11 with an adhesive or the like. The surfaces of conductive wires (wires formed of copper, a copper alloy, or the like) forming the coil 12 are insulated. For the ease of understanding, FIG. 3 illustrates the coil 12 in a simplified manner, and omits illustration of a detailed winding state. The same applies to the other drawings.

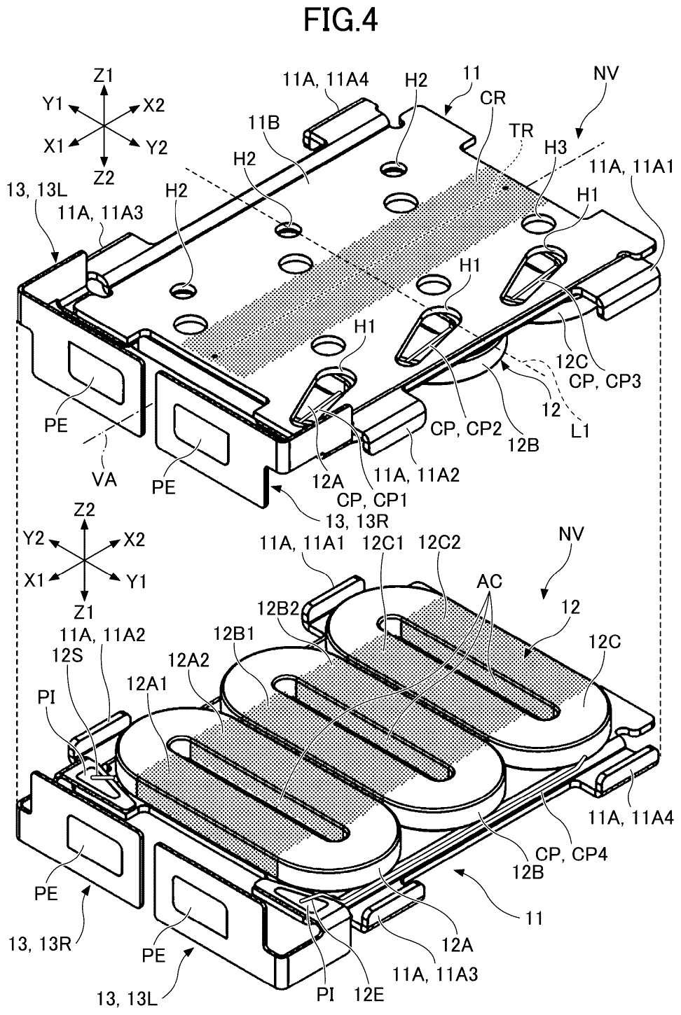

The wiring board 13 is a member to which the first end 12S and the second end 12E of the coil 12 are to be connected. In the present embodiment, the wiring board 13 is fixed to the Z2-side (lower) surface of the bracket 11 with an adhesive, as illustrated in the lower view of FIG. 4. FIG. 4 is a perspective view of the non-vibrating body NV. Specifically, the upper view of FIG. 4 is a perspective view of an upper part of the non-vibrating body NV, and the lower view of FIG. 4 is a perspective view of a lower part of the non-vibrating body NV.

In the illustrated example, the wiring board 13 is a flexible wiring board having flexibility, and includes a left wiring board 13L and a right wiring board 13R. The left wiring board 13L and the right wiring board 13R are fixed to an X1-side (front) end of the bracket 11 with an adhesive or the like. As illustrated in the lower view of FIG. 4, the first end 12S of the coil 12 is connected to an inner conductor pattern PI of the right wiring board 13R with a solder, a conductive adhesive, or the like, and the second end 12E of the coil 12 is connected to the inner conductor pattern PI of the left wiring board 13L with a solder, a conductive adhesive, or the like. An outer conductor pattern PE of each of the left wiring board 13L and the right wiring board 13R is connected to a conductive wire from the controller

CTR with a solder, a conductive adhesive, or the like.

Each of the first coil-wound portion 12A, the second coil-wound portion 12B, and the third coil-wound portion 12C has an air-core portion AC. The first end 12S, the first coil-wound portion 12A, the second coil-wound portion 12B, the third coil-wound portion 12C, and the second end 12E are connected by a conductive wire CP. Specifically, the conductive wire CP includes a first conductive wire CP1 to a fourth conductive wire CP4. The first end 12S and the first coil-wound portion 12A are connected by the first conductive wire CP1, the first coil-wound portion 12A and the second coil-wound portion 12B are connected by the second conductive wire CP2, the second coil-wound portion 12B and the third coil-wound portion 12C are connected by the third conductive wire CP3, and the third coil-wound portion 12C and the second end 12E are connected by the fourth conductive wire CP4.

The coil 12 also includes wire bundles extending along the Y-axis direction. Specifically, the first coil-wound portion 12A includes a front wire bundle 12A1 and a rear wire bundle 12A2, the second coil-wound portion 12B includes a front wire bundle 12B1 and a rear wire bundle 12B2, and the third coil-wound portion 12C includes a front wire bundle 12C1 and a rear wire bundle 12C2. In the lower view of FIG. 4, for the ease of understanding, a dot pattern is provided to the wire bundles of the coil 12.

The magnet 15 is an example of a magnetic flux generating member, and forms the driver DM along with the coil 12. In the present embodiment, the magnet 15 includes an upper magnet 15U and a lower magnet 15D. Each of the upper magnet 15U and the lower magnet 15D is an 8-pole magnetized permanent magnet having a substantially rectangular parallelepiped outer shape. Specifically, the upper magnet 15U includes a first upper magnet portion 15U1 to a fourth upper magnet portion 15U4, and the lower magnet 15D includes a first lower magnet portion 15D1 to a fourth lower magnet portion 15D4. Each of the first upper magnet portion 15U1 to the fourth upper magnet portion 15U4 and the first lower magnet portion 15D1 to the fourth lower magnet portion 15D4 includes a single N-pole portion and a single S-pole portion. In the illustrated example, the top surface of each of the first upper magnet portion 15U1, the third upper magnet portion 15U3, the first lower magnet portion 15D1, and the third lower magnet portion 15D3 is an N pole, and the top surface of each of the second upper magnet portion 15U2, the fourth upper magnet portion 15U4, the second lower magnet portion 15D2, and the fourth lower magnet portion 15D4 is an S pole. In FIG. 3, for the ease of understanding, a dot pattern is provided to the N pole of the 8-pole magnetized permanent magnet, and a cross pattern is provided to the S pole of the 8-pole magnetized permanent magnet. The same applies to the other drawings. Each of the upper magnet 15U and the lower magnet 15D may be a combination of four 2-pole magnetized permanent magnets or a combination of two 4-pole magnetized permanent magnets.

The leaf spring 17 is an example of the elastic supporting member ES, which is configured to elastically support the vibrating body VB with the elastic supporting member ES being between the housing HS and the vibrating body VB. In the present embodiment, the leaf spring 17 is formed of a non-magnetic material, such as austenitic stainless steel or the like, and includes a connecting portion 17A, a vibrating body support 17B, and an elastic arm 17C, as illustrated in FIG. 3.

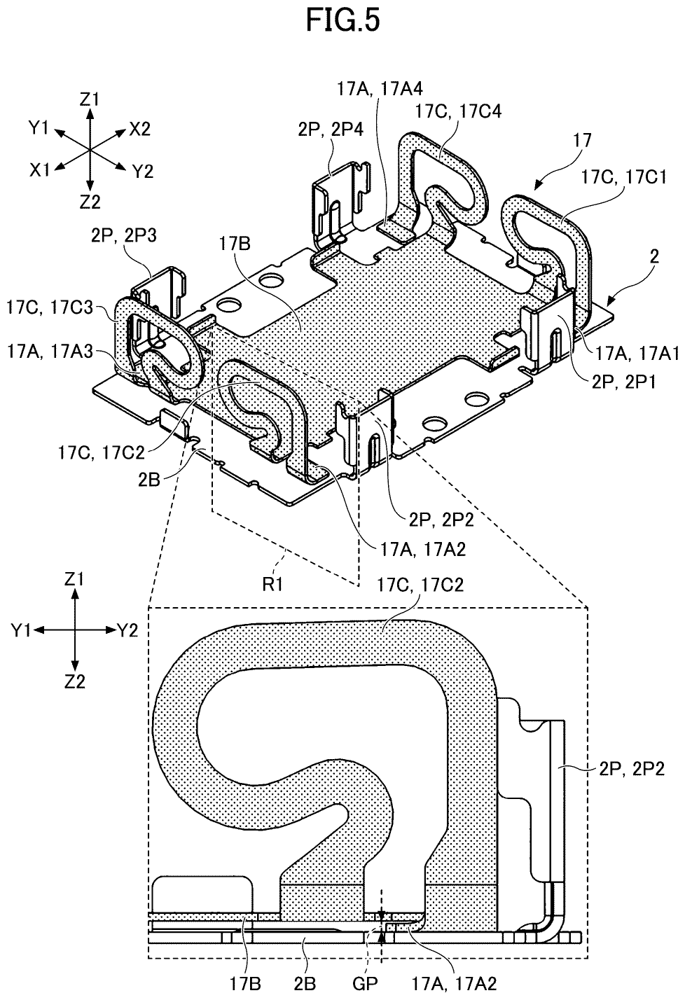

Specifically, the leaf spring 17 is formed, for example, by punching and bending a metal plate formed of austenitic stainless steel and having a thickness of 0.2 mm. More specifically, as illustrated in FIG. 5, the connecting portion 17A of the leaf spring 17 is welded to a bottom plate 2B of the base member 2. The leaf spring 17 is attached to the base member 2 only via the connecting portion 17A in a state in which a gap GP is formed between the bottom plate 2B of the base member 2 and the vibrating body support 17B such that the vibrating body support 17B and the elastic arm 17C do not contact the base member 2.

FIG. 5 is a view illustrating a configuration example of the base member 2 and the elastic supporting member ES (the leaf spring 17). Specifically, the upper view of FIG. 5 is a perspective view of the base member 2 to which the elastic supporting member ES (the leaf spring 17) is attached. The lower view of FIG. 5 is a front view of the base member 2 to which the elastic supporting member ES (the leaf spring 17) is attached, and corresponds to an enlarged view of a region R1 enclosed by a dashed line in the upper view of FIG. 5. In FIG. 5, for the ease of understanding, a dot pattern is provided to the elastic supporting member ES (the leaf spring 17).

In the present embodiment, the connecting portion 17A of the leaf spring 17 includes a first connecting portion 17A1 to a fourth connecting portion 17A4, and the elastic arm 17C of the leaf spring 17 includes a first elastic arm 17C1 to a fourth elastic arm 17C4, as illustrated in the upper view of FIG. 5.

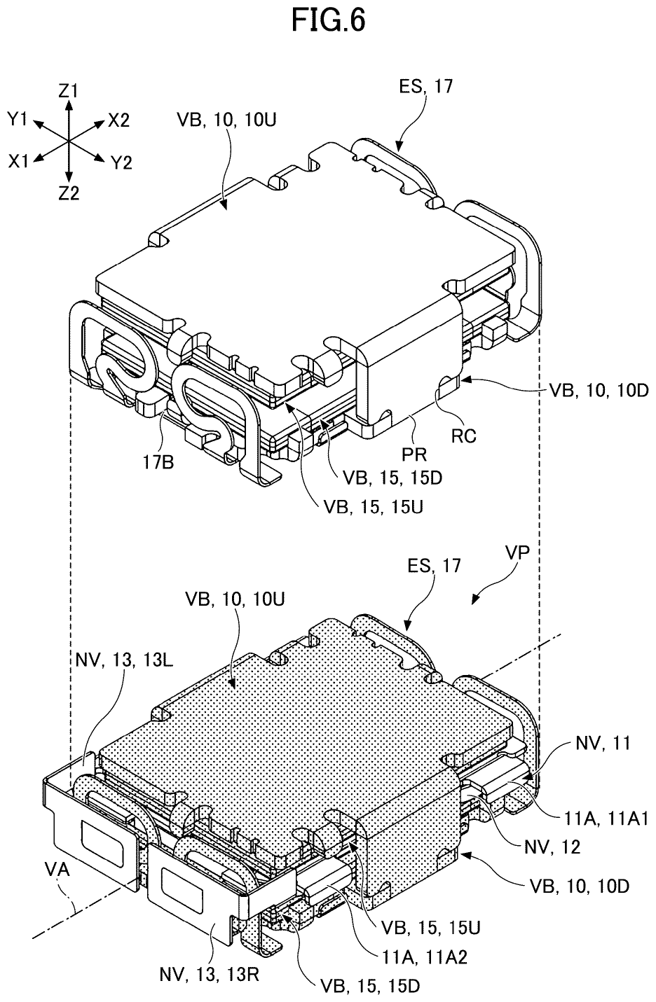

Each of the first connecting portion 17A1 to the fourth connecting portion 17A4 is fixed to the bottom plate 2B of the base member 2 by means of welding, as illustrated in the upper view of FIG. 5. The vibrating body VB is welded to the vibrating body support 17B of the leaf spring 17, as illustrated in FIG. 6. FIG. 6 is a perspective view of the vibrating portion VP. Specifically, the upper view of FIG. 6 is a perspective view of the vibrating portion VP (the elastic supporting member ES and the vibrating body VB) in a state in which illustration of the non-vibrating body NV (the bracket 11, the coil 12, and the wiring board 13) is omitted. The lower view of FIG. 6 is a perspective view of the vibrating portion VP in a state in which the non-vibrating body NV is illustrated. In the lower view of FIG. 6, for the ease of understanding, a dot pattern is provided to vibrating portions (the vibrating body VB and the elastic supporting member ES). The presence or absence of the dot pattern indicates that the non-vibrating body NV provided with no dot pattern is fixed to the base member 2 (not illustrated in the lower view of FIG. 6) so as not to contact the vibrating body VB provided with the dot pattern. The lower view of FIG. 1 illustrates the non-vibrating body NV that is fixed to the base member 2 so as not to contact the vibrating body VB.

Specifically, as illustrated in the upper view of FIG. 6, the vibrating body VB is formed by the upper yoke 10U, the upper magnet 15U, the lower magnet 15D, and the lower yoke 10D. The Z2-side (lower) surface of the bottom plate BW of the lower yoke 10D is welded to the Z1-side (upper) surface of the vibrating body support 17B of the leaf spring 17.

When an alternating current is applied to the coil 12 via the wiring board 13 in the state illustrated in the lower view of FIG. 6, the vibrating body VB vibrates along the vibration axis VA.

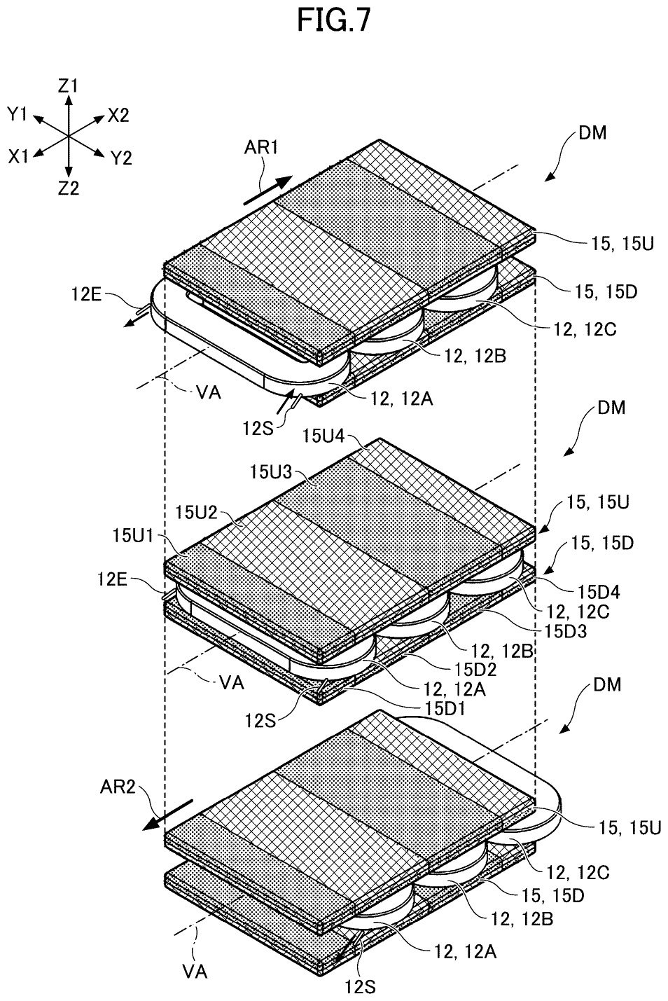

A positional relationship of the components of the driver DM when the vibrating body VB vibrates along the vibration axis VA will be described with reference to FIG. 7. FIG. 7 is a perspective view of the components of the driver DM. Specifically, the upper view of FIG. 7 illustrates a positional relationship between the non-vibrating body NV (the coil 12) and the vibrating body VB (the magnet 15) when the vibrating body VB (the magnet 15) moves the farthest to the X2 side (rear side) in response to flowing of a current through the coil 12 in one direction. The center view of FIG. 7 illustrates a positional relationship between the non-vibrating body NV (the coil 12) and the vibrating body VB (the magnet 15) when no current is flowing through the coil 12. The lower view of FIG. 7 illustrates a positional relationship between the non-vibrating body NV (the coil 12) and the vibrating body VB (the magnet 15) when the vibrating body VB (the magnet 15) moves the farthest to the X1 side (front side) in response to flowing of a current through the coil 12 in the other direction.

When no current is flowing through the coil 12, the coil 12 does not generate a magnetic field. Thus, a repulsive force or an attractive force is not generated between the coil 12 and the magnet 15. Therefore, the magnet 15 is positioned at a neutral position such that the center of the magnet 15 faces the center of the coil 12 (the second coil-wound portion 12B), as illustrated in the center view of FIG. 7. Specifically, the vibrating body VB (the magnet 15) located at a position other than the neutral position is forced to return to the neutral position by the elastic supporting member ES (the leaf spring 17).

When a current is flowing from the first end 12S toward the second end 12E of the coil 12, the first coil-wound portion 12A generates a magnetic field such that the Z1 side becomes an N pole and the Z2 side becomes an S pole, the second coil-wound portion 12B generates a magnetic field such that the Z2 side becomes an N pole and the Z1 side becomes an S pole, and the third coil-wound portion 12C generates a magnetic field such that the Z1 side becomes an N pole and the Z2 side becomes an S pole. As a result, the N-pole portion of the second upper magnet portion 1502 is moved away from the first coil-wound portion 12A and attracted toward the second coil-wound portion 12B, the S-pole portion of the third upper magnet portion 1503 is moved away from the second coil-wound portion 12B and attracted toward the third coil-wound portion 12C, the S-pole portion of the second lower magnet portion 15D2 is moved away from the first coil-wound portion 12A and attracted toward the second coil-wound portion 12B, and the N-pole portion of the third lower magnet portion 15D3 is moved away from the second coil-wound portion 12B and attracted toward the third coil-wound portion 12C. Thus, the vibrating body VB (the magnet 15) moves to the X2 side (rear side), as indicated by arrow ARI in the upper view of FIG. 7.

On the other hand, when a current is flowing from the second end 12E toward the first end 12S of the coil 12, the first coil-wound portion 12A generates a magnetic field such that the Z1 side becomes an S pole and the Z2 side becomes an N pole, the second coil-wound portion 12B generates a magnetic field such that the 22 side becomes an S pole and the Z1 side becomes an N pole, and the third coil-wound portion 12C generates a magnetic field such that the Z1 side becomes an S pole and the Z2 side becomes an N pole. As a result, the N-pole portion of the second upper magnet portion 1502 is moved away from the second coil-wound portion 12B and attracted toward the first coil-wound portion 12A, the S-pole portion of the third upper magnet portion 1503 is moved away from the third coil-wound portion 12C and attracted toward the second coil-wound portion 12B, the S-pole portion of the second lower magnet portion 15D2 is moved away from the second coil-wound portion 12B and attracted toward the first coil-wound portion 12A, and the N-pole portion of the third lower magnet portion 15D3 is moved away from the third coil-wound portion 12C and attracted toward the second coil-wound portion 12B. Thus, the vibrating body VB (the magnet 15) moves to the X1 side (front side), as indicated by arrow AR2 in the lower view of FIG. 7.

The controller CTR can alternately reverse the direction of a magnetic field that is generated by the coil 12 in which the direction of the current flowing through the coil 12 is alternately reversed. Hence, the controller CTR enables the vibrating body VB (the magnet 15) to vibrate along the vibration axis VA (the X-axis direction).

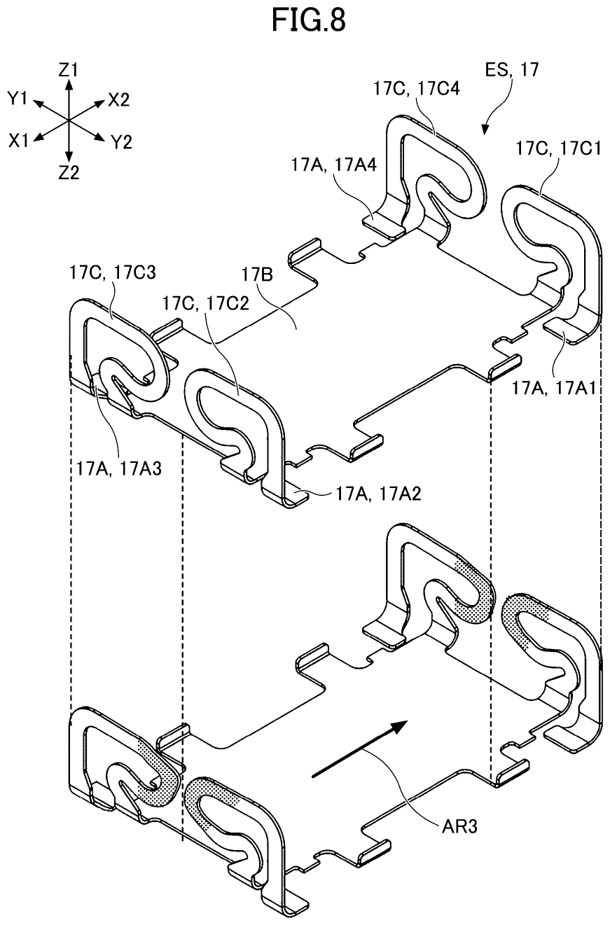

Next, a movement of the elastic arm 17C when the vibrating body VB vibrates will be described with reference to FIG. 8. FIG. 8 is a perspective view of the leaf spring 17. Specifically, the upper view of FIG. 8 illustrates a state of the leaf spring 17 when no current is flowing through the coil 12, i.e., when the vibrating body VB is at the neutral position (not vibrating). The lower view of FIG. 8 illustrates a state of the leaf spring 17 when the vibrating body VB moves to the X2 side (rear side).

As illustrated in the upper view of FIG. 8, the elastic arm 17C is provided between the connecting portion 17A and the vibrating body support 17B. Specifically, the first elastic arm 17C1 is provided between the first connecting portion 17A1 and the vibrating body support 17B, the second elastic arm 17C2 is provided between the second connecting portion 17A2 and the vibrating body support 17B, the third elastic arm 17C3 is provided between the third connecting portion 17A3 and the vibrating body support 17B, and the fourth elastic arm 17C4 is provided between the fourth connecting portion 17A4 and the vibrating body support 17B.

When the vibrating body VB (not illustrated in FIG. 8) is moved by the driver DM in a direction indicated by arrow AR3, the elastic arm 17C bends as illustrated in the lower view of FIG. 8, and thus enables the vibrating body VB to translate in an X2 direction. In FIG. 8, for the ease of understanding, a dot pattern is provided to portions of the elastic arm 17C that deflect to a relatively large extent.

On the other hand, when the vibrating body VB is moved by the driver DM in a direction (an X1 direction) opposite to the direction indicated by arrow AR3 (the X2 direction), the elastic arm 17C bends in a direction opposite to the deflection direction illustrated in the lower view of FIG. 8, and enables the vibrating body VB to translate in the X1 direction.

Here, details of the upper yoke 10U will be described with reference to FIG. 3. The upper yoke 10U includes the top plate TW, the right side plate RW, and the left side plate LW. Specifically, the left side plate LW extending in a Z2 direction is formed at the Y1-side end of the top plate TW, and the right side plate RW extending in the Z2 direction is formed at the Y2-side end of the top plate TW. Also, the projecting portion PR is formed at each of the lower ends of the left side plate LW and the right side plate RW so as to engage with the recessed portion RC formed in the lower yoke 10D. The upper view of FIG. 6 illustrates a state in which the recessed portion RC formed in the lower yoke 10D is engaged with the projecting portion PR of the upper yoke 10U.

When the vibrating body VB is assembled, the upper magnet 15U is attached to the top plate TW (see FIG. 3) of the upper yoke 10U, the lower magnet 15D is attached to the bottom plate BW (see FIG. 3) of the lower yoke 10D, and the projecting portion PR of the upper yoke 100 is engaged with the recessed portion RC of the lower yoke 10D. Thus, in the present embodiment, the upper yoke 10U and the lower yoke 10D enclosing the magnet 15 are separate members so as to facilitate assembly of the vibrating body VB.

Also, as illustrated in the upper view of FIG. 6, the Z1-side (upper) surface of the upper magnet 15U is bonded, by a magnetic force, to the Z2-side (lower) surface of the top plate TW of the upper yoke 10U, and the Z2-side (lower) surface of the lower magnet 15D is bonded, by a magnetic force, to the Z1-side (upper) surface of the bottom plate BW of the lower yoke 10D. As illustrated in the lower view of FIG. 6, a space enclosed by the upper yoke 10U and the lower yoke 10D includes the coil 12 that is fixed to the bracket 11 on the Z2 side of the upper magnet 15U and on the Z1 side of the lower magnet 15D in a state in which the coil 12 does not contact the upper magnet 15U and the lower magnet 15D.

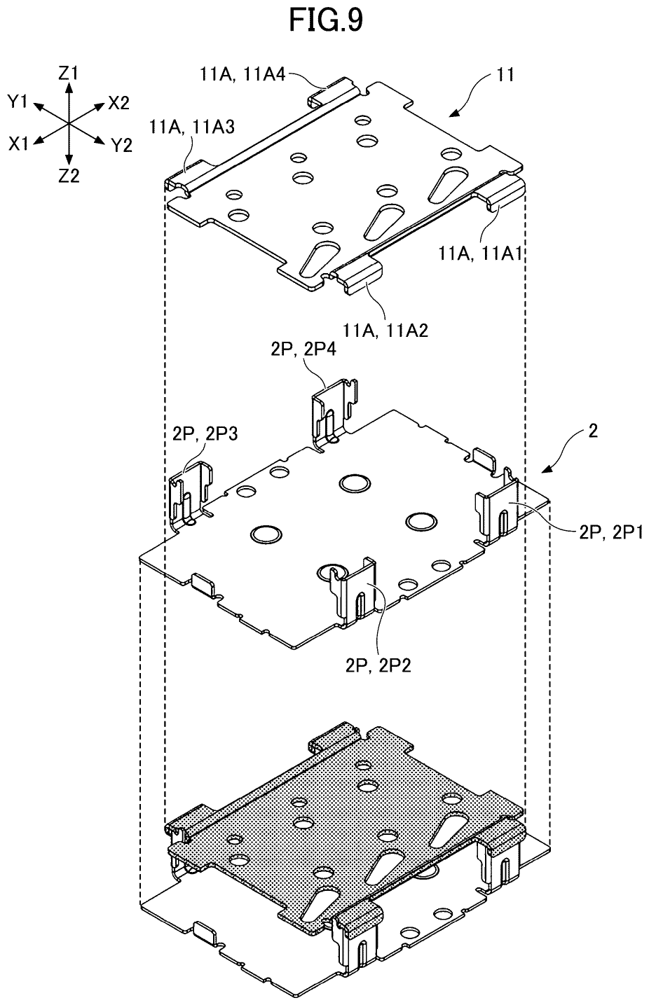

As illustrated in FIG. 9, the bracket 11 is attached to the base member 2 by engaging the connecting portion 11A provided at the bracket 11 with a supporting portion 2P provided at the base member 2. FIG. 9 is a view illustrating configuration examples of the base member 2 and the bracket 11. Specifically, the upper view of FIG. 9 is a perspective view of the bracket 11, the center view of FIG. 9 is a perspective view of the base member 2, and the lower view of FIG. 9 is a perspective view of the bracket 11 attached to the base member 2.

As illustrated in FIG. 9, the connecting portion 11A includes a first connecting portion 11A1 to a fourth connecting portion 11A4. Also, the supporting portion 2P includes a first supporting portion 2P1 to a fourth supporting portion 2P4. The first connecting portion 11A1 is engaged with the first supporting portion 2P1, the second connecting portion 11A2 is engaged with the second supporting portion 2P2, the third connecting portion 11A3 is engaged with the third supporting portion 2P3, and the fourth connecting portion 11A4 is engaged with the fourth supporting portion 2P4. In the illustrated example, the connecting portion 11A and the supporting portion 2P are bonded by means of welding. However, the connecting portion 11A and the supporting portion 2P may be bonded with a fastening member, an adhesive, caulking, or the like.

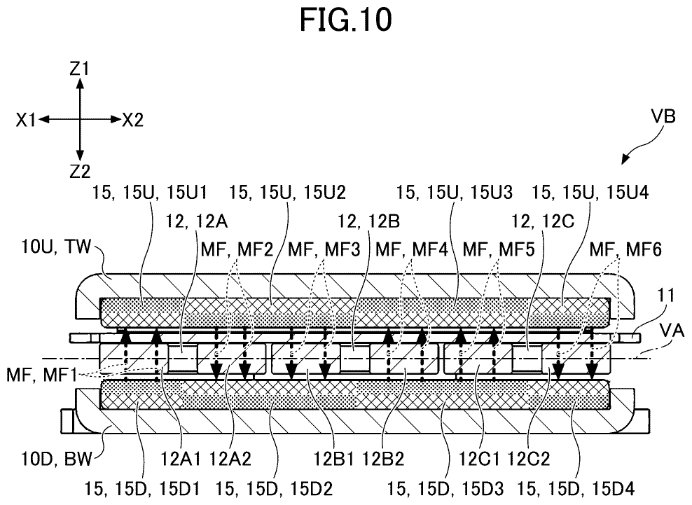

Next, the magnetic flux generated by the magnet 15 will be described with reference to FIG. 10. FIG. 10 is a cross-sectional view of the vibrating body VB. Specifically, FIG. 10 illustrates the vibrating body VB formed by the upper yoke 10U, the upper magnet 15U, the lower magnet 15D, and the lower yoke 10D; and the coil 12 disposed inside a space enclosed by the upper yoke 10U and the lower yoke 10D (a space between the upper magnet 15U and the lower magnet 15D). The magnet 15 generates magnetic fluxes denoted by magnetic field lines MF, as indicated by dotted lines in FIG. 10. In the example illustrated in FIG. 10, the magnetic field lines MF include first magnetic field lines MF1 to sixth magnetic field lines MF6.

Specifically, when no current flows through the coil 12, the first magnetic field line MF1 exits from the N-pole portion of the first lower magnet portion 15D1 of the lower magnet 15D, passes through the front wire bundle 12A1 of the first coil-wound portion 12A, and enters the S-pole portion of the first upper magnet portion 15U1 of the upper magnet 15U. The second magnetic field line MF2 exits from the N-pole portion of the second upper magnet portion 1502 of the upper magnet 15U, passes through the rear wire bundle 12A2 of the first coil-wound portion 12A, and enters the S-pole portion of the second lower magnet portion 15D2 of the lower magnet 15D. The third magnetic field line MF3 exits from the N-pole portion of the second upper magnet portion 1502 of the upper magnet 15U, passes through the front wire bundle 12B1 of the second coil-wound portion 12B, and enters the S-pole portion of the second lower magnet portion 15D2 of the lower magnet 15D. The fourth magnetic field line MF4 exits from the N-pole portion of the third lower magnet portion 15D3 of the lower magnet 15D, passes through the rear wire bundle 12B2 of the second coil-wound portion 12B, and enters the S-pole portion of the third upper magnet portion 1503 of the upper magnet 150. The fifth magnetic field line MF5 exits from the N-pole portion of the third lower magnet portion 15D3 of the lower magnet 15D, passes through the front wire bundle 12C1 of the third coil-wound portion 12C, and enters the S-pole portion of the third upper magnet portion 1503 of the upper magnet 150. The sixth magnetic field line MF6 exits from the N-pole portion of the fourth upper magnet portion 1504 of the upper magnet 15U, passes through the rear wire bundle 12C2 of the third coil-wound portion 12C, and enters the S-pole portion of the fourth lower magnet portion 15D4 of the lower magnet 15D.

Therefore, in the space enclosed by the upper yoke 10U and the lower yoke 10D, the magnetic field lines are concentrated in a partial space between the upper magnet 15U and the lower magnet 15D, i.e., the magnetic flux density is high. The coil 12 is disposed in this partial space.

Therefore, according to this configuration, by causing a current to flow between the first end 12S and the second end 12E of the coil 12, a Lorentz force can be efficiently generated, and the vibrating body VB can be efficiently vibrated along the X-axis direction.

For example, when a current flows from the first end 12S toward the second end 12E of the coil 12, the vibrating body VB moves to the X2 side (rear side). When a current flows from the second end 12E toward the first end 12S of the coil 12, the vibrating body VB moves to the X1 side (front side). Therefore, the controller CTR can vibrate the vibrating body VB along the vibration axis VA by causing a current to flow through the coil 12 such that the direction of the current is alternately reversed. The bracket 11 to which the coil 12 is attached is fixed to the base member 2, and is not fixed to the vibrating body VB. Thus, the bracket 11 and the coil 12 do not vibrate along with the vibrating body VB.

Also, when the vibrating body VB vibrates along the vibration axis VA, the magnetic flux (hereinafter referred to as an “effective magnetic flux”) extending in a Z-axis direction and generated between the upper magnet 15U and the lower magnet 15D included in the vibrating body VB also vibrates along the vibration axis VA. That is, the effective magnetic flux crossing the bracket 11, which is the conductive member, between the upper magnet 150 and the lower magnet 15D vibrates along the vibration axis VA while maintaining a relationship in which the effective magnetic flux crosses the bracket 11. Therefore, an eddy current flows through the plate-like portion 11B of the bracket 11. In the illustrated example, the upper magnet 15U, the lower magnet 15D, and the bracket 11 are disposed such that the effective magnetic flux and the plate-like portion 11B are orthogonal to each other.

The vibrating body VB always receives a braking force, a force caused by the eddy current, acting in the direction opposite to the vibration direction. Specifically, while the vibrating body VB is being vibrated by the Lorentz force generated by the driver DM, the vibrating body VB receives a braking force acting to attenuate the generated vibration. The braking force increases in proportion to the vibration speed of the vibrating body VB. Therefore, the vibration acceleration of the vibrating body VB at and near the natural frequency is reduced by the braking force.

The braking force caused by the eddy current increases as the eddy current increases. The eddy current increases as the specific resistance of the conductive member (the bracket 11) decreases. The eddy current increases as the conductivity of the conductive member (the bracket 11) increases. The eddy current increases as the thickness of the conductive member (the bracket 11) (the thickness of the plate-like portion 11B) increases. Therefore, the material and thickness of the bracket 11 are selected so as to obtain a desired magnitude of the braking force. In the illustrated example, the bracket 11 is formed of tough-pitch copper, which is a material the same as the material of the wire of the coil 12, and has a thickness of about 0.3 mm.

With this configuration, the vibration generating device 101 can be increased in durability compared to a case in which a viscoelastic member for generating a braking force is provided between the vibrating body VB and the non-vibrating body NV. This is because, while the viscoelastic member is prone to effects of ambient temperature, variation in dimensions, degradation, delamination, breakage, and the like, the bracket 11 is not prone to these effects.

As illustrated in the upper view of FIG. 4, the bracket 11 is formed to have a plurality of openings (three first openings H1, three second openings H2, and six third openings H3). At least one of the plurality of openings may be a notch.

Each of the first openings H1 is a non-circular (substantially teardrop-shaped) opening for preventing the upper surface of the coil 12 from tilting with respect to the bottom surface of the plate-like portion 11B due to interference between the plate-like portion 11B and the conductive wire CP when the coil 12 is attached to the bottom surface of the plate-like portion 11B of the bracket 11.

Each of the second openings H2 is a substantially circular opening for receiving an unillustrated jig used for positioning the air-core portion AC of the coil 12. The unillustrated jig is, for example, a cylindrical bar member. In the illustrated example, the first openings H1 also function as an opening for receiving the jig.

Each of the third openings H3 is a substantially circular opening for insertion of a jig for maintaining an appropriate clearance between the bracket 11 and the coil 12 when applying an adhesive between the bottom surface of the plate-like portion 11B of the bracket 11 and the top surface of the coil 12.

In the illustrated example, the first openings H1 to the third openings H3 are each formed at a position that is not on a trajectory TR. The trajectory TR is a trajectory on the plate-like portion 11B on which the center axes of the effective magnetic fluxes pass when the vibrating body VB vibrates. That is, the vibration generating device 101 is configured such that the center axes of the effective magnetic fluxes extending along the Z-axis direction move in the X-axis direction along the trajectory TR, which is in the form of a straight line. In the illustrated example, the center axes of the effective magnetic fluxes include the center axis of the effective magnetic flux generated by each of the first lower magnet portion 15D1, the second upper magnet portion 15U2, the third lower magnet portion 15D3, and the fourth upper magnet portion 15U4, as illustrated by the magnetic field lines MF in FIG. 10. The trajectory TR is positioned on the vibration axis VA in a top view. The center axes of the effective magnetic fluxes may be read as the respective coil axes of the first coil-wound portion 12A, the second coil-wound portion 12B, and the third coil-wound portion 12C.

In other words, each of the first openings H1 to the third openings H3 is formed at a position that is not in a center region CR. The center region CR is a region including the trajectory TR located at the center portion of the plate-like portion 11B. Specifically, the center region CR is a region in which an eddy current flows that is generated by the effective magnetic fluxes generated by the magnet 15 and the conductive member (the bracket 11) disposed so as to cross the effective magnetic fluxes. In the upper view of FIG. 4, for the ease of understanding, a dot pattern is provided to the center region CR.

In the illustrated example, openings, like the first openings H1 to the third openings H3, are not formed in the rectangular center region CR in the plate-like portion 11B. Thus, the vibration generating device 101 provides the effect that an eddy current is more likely to flow than when openings are formed in the center region CR. Also, the rectangular center region CR in the plate-like portion 11B is flat and does not include recesses, projections, or the like. The vibration generating device 101 provides the effect that an eddy current is more likely to flow than when the center region CR includes recesses, projections, or the like and is not flat.

In a top view, the center region CR is in a left-right symmetry with respect to the vibration axis VA, and is in a front-rear symmetry with respect to a line segment L1 (see the upper view of FIG. 4) expressing a lateral axis passing through the center point of the bracket 11. This configuration provides the effect that the magnitude of the braking force when the vibrating body VB moves forward (the X1 direction) is the same as the magnitude of the braking force when the vibrating body VB moves rearward (the X2 direction).

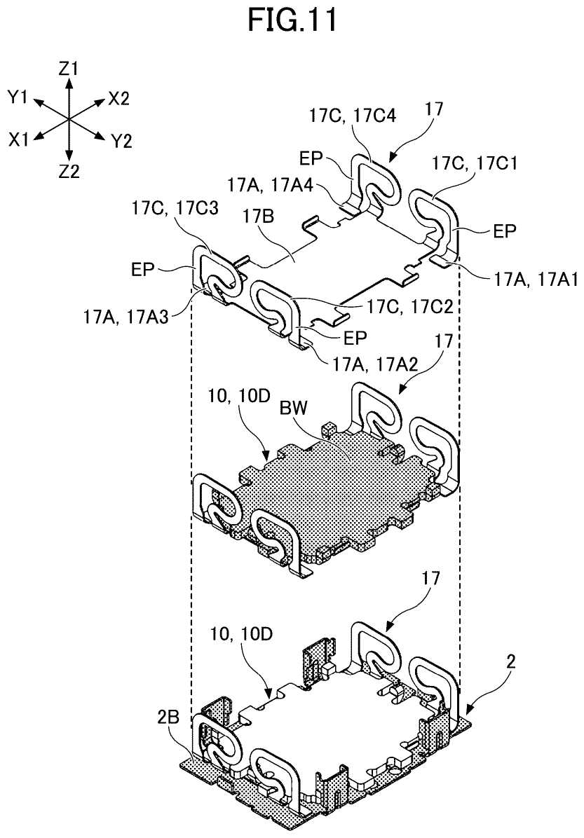

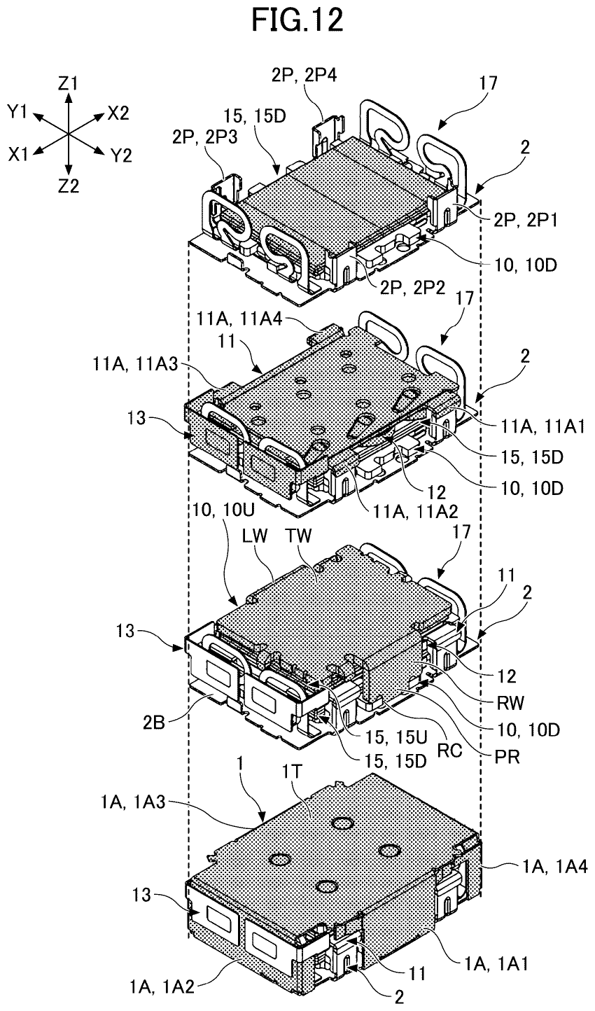

Next, a method of assembling the vibration generating device 101 will be described with reference to FIGS. 11 and 12. FIGS. 11 and 12 are perspective views of the members forming the vibration generating device 101. In FIGS. 11 and 12, for the ease of understanding, a dot pattern is provided to members that are newly attached.

Specifically, the upper view of FIG. 11 is a perspective view of the leaf spring 17, the center view of FIG. 11 is a perspective view of the leaf spring 17 to which the lower yoke 10D is attached, and the lower view of FIG. 11 is a perspective view of the base member 2 to which the leaf spring 17 in a state illustrated in the center view of FIG. 11 is attached.

The uppermost view of FIG. 12 is a perspective view of the base member 2 to which the lower magnet 15D is further attached, the second uppermost view of FIG. 12 is a perspective view of the base member 2 to which the bracket 11 and the coil 12 are further attached, the third uppermost view of FIG. 12 is a perspective view of the base member 2 to which the upper yoke 10U and the wiring board 13 are further attached, and the lowermost view of FIG. 12 is a perspective view of the base member 2 to which the cover member 1 is further attached.

First, as illustrated in the center view of FIG. 11, the lower yoke 10D is stacked on the top surface of the vibrating body support 17B of the leaf spring 17. In the illustrated example, the bottom plate BW of the lower yoke 10D is stacked on the top surface of the vibrating body support 17B without application of an adhesive. A damping steel plate (not illustrated) serving as a reinforcing material for suppressing deflection of an upright portion EP may be attached to the outer surface of the upright portion EP of the elastic arm 17C of the leaf spring 17.

Subsequently, the leaf spring 17, on which the lower yoke 10D is stacked, is disposed on the top surface of the bottom plate 2B of the base member 2, as illustrated in the lower view of FIG. 11. Then, the lower yoke 10D and the leaf spring 17 are bonded, and the base member 2 and the leaf spring 17 are bonded. In the illustrated example, the bottom plate BW of the lower yoke 10D is bonded to the top surface of the vibrating body support 17B of the leaf spring 17 by means of laser welding, and the connecting portion 17A of the leaf spring 17 is bonded to the top surface of the bottom plate 2B of the base member 2 by means of laser welding.

Subsequently, the lower magnet 15D is stacked on the top surface of the bottom plate BW of the lower yoke 10D, as illustrated in the uppermost view of FIG. 12. In the illustrated example, the lower yoke 10D and the lower magnet 15D are attracted to each other by a magnetic force. Thus, bonding by means of laser welding is not performed, and bonding by means of an adhesive is not performed. However, the lower yoke 10D and the lower magnet 15D may be bonded by means of laser welding or an adhesive.

Subsequently, the non-vibrating body NV is attached to the base member 2, as illustrated in the second uppermost view of FIG. 12. In the illustrated example, the non-vibrating body NV includes the bracket 11, the coil 12, and the wiring board 13. The supporting portion 2P of the base member 2 and the connecting portion 11A of the bracket 11 are bonded by means of fastening members, caulking, laser welding, an adhesive, or the like. In the illustrated example, the supporting portion 2P and the connecting portion 11A are bonded with an adhesive. Before the non-vibrating body NV is attached to the base member 2, the coil 12 is bonded to the bracket 11 with an adhesive, and the wiring board 13 is bonded to the bracket 11 with double-sided tape.

Subsequently, the upper yoke 10U, to which the upper magnet 15U is attached, is bonded to the lower yoke 10D at a position that does not contact the non-vibrating body NV, as illustrated in the third uppermost view of FIG. 12. Specifically, the upper yoke 10U and the lower yoke 10D are bonded by means of welding, an adhesive, or the like at a portion at which the recessed portion RC formed in the lower yoke 10D is engaged with the projecting portion PR of the upper yoke 10U. In the illustrated example, the upper yoke 10U and the lower yoke 10D are bonded by means of laser welding.

Before the upper yoke 10U is bonded to the lower yoke 10D, the upper magnet 15U is stacked on the bottom surface of the top plate TW of the upper yoke 10U in the same manner as when the lower magnet 15D is stacked on the top surface of the bottom plate BW of the lower yoke 10D. The upper yoke 10U and the upper magnet 15U are attracted to each other by a magnetic force. Thus, bonding by means of laser welding is not performed, and bonding by means of an adhesive is not performed. However, the upper yoke 10U and the upper magnet 15U may be bonded by means of laser welding or an adhesive.

Subsequently, as illustrated in the lowermost view of FIG. 12, the cover member 1 is attached so as to cover the members other than the base member 2 and the wiring board 13. In the illustrated example, the lower end of the outer peripheral wall 1A of the cover member 1 and the peripheral edge of the bottom plate 2B of the base member 2 are bonded by means of laser welding. The cover member 1 and the base member 2 may be bonded by means of a fastening member, an adhesive, caulking, or the like.

In this manner, the vibration generating device 101 is assembled. The adhesive used in the above-described assembling process may be, for example, a thermosetting adhesive, a photocurable adhesive, a moisture-curable adhesive, or a hybrid adhesive, which is a combination thereof. In the illustrated example, the adhesive is a thermosetting adhesive.

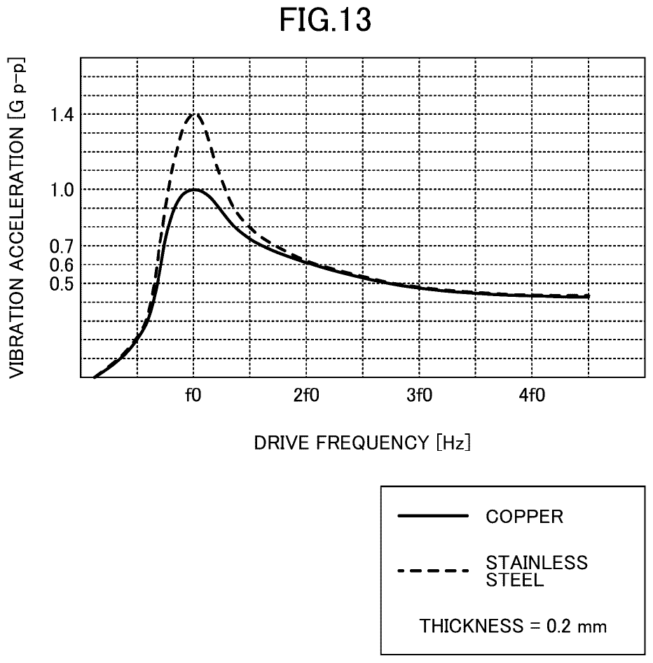

Next, a relationship between the drive frequency and the vibration acceleration of the vibrating body VB will be described with reference to FIG. 13. FIG. 13 is a graph indicating a relationship between the drive frequency and the vibration acceleration of the vibrating body VB, and the horizontal axis indicates a drive frequency [Hz] and the vertical axis indicates a vibration acceleration [G p-p]. A solid graph line in FIG. 13 indicates a relationship between the drive frequency [Hz] and the vibration acceleration [G p-p] when the bracket 11 formed of copper is used. A dashed graph line in FIG. 13 indicates a relationship between the drive frequency and the vibration acceleration when a bracket formed of stainless steel is used rather than the bracket 11 formed of copper. The bracket 11 formed of copper and the bracket formed of stainless steel are formed to have the same size and the same shape. The thickness of the bracket 11 formed of copper and the thickness of the bracket formed of stainless steel are both 0.2 [mm]. Value f0 of the drive frequency corresponds to a resonance frequency (natural frequency) of the vibrating body VB, and vibrating the vibrating body VB at the drive frequency of the value f0 means vibrating the vibrating body VB at the resonance frequency. Similarly, value 2f0 of the drive frequency corresponds to the frequency two times higher than the resonance frequency of the vibrating body VB, and vibrating the vibrating body VB at the drive frequency of the value 2f0 means vibrating the vibrating body VB at a frequency two times higher than the resonance frequency. The same applies to value 3f0 of the drive frequency (a frequency three times higher than the resonance frequency) and value 4f0 of the drive frequency (a frequency four times higher than the resonance frequency).

In the case of the bracket 11 formed of copper, as indicated by the solid graph line, when the drive frequency is the value f0, the vibration acceleration of the vibrating body VB is value 1.0, and when the drive frequency is the value 2f0, the vibration acceleration is value 0.6. That is, the value 1.0 of the vibration acceleration upon the vibrating body VB being vibrated by driving the vibrating body VB at the resonance frequency is equal to or less than two times (approximately 1.67 times) the value 0.6 of the vibration acceleration upon the vibrating body VB being vibrated by driving the vibrating body VB at the frequency two times higher than the resonance frequency.

On the other hand, in the case of the bracket of stainless steel, when the drive frequency is the value f0, the vibration acceleration of the vibrating body VB is value 1.4, and when the drive frequency is the value 2f0, the vibration acceleration of the vibrating body VB is value 0.6. That is, the value 1.4 of the vibration acceleration upon the vibrating body VB being vibrated by driving the vibrating body VB at the resonance frequency is greater than two times, approximately 2.33 times, the value 0.6 of the vibration acceleration upon the vibrating body VB being vibrated by driving the vibrating body VB at the frequency two times higher than the resonance frequency.

In this manner, when the bracket 11 formed of copper is used, the vibration generating device 101 can suppress the value of the vibration acceleration upon the vibrating body VB being driven at the resonance frequency to be equal to or less than two times the value of the vibration acceleration upon the vibrating body VB being driven at the frequency two times higher than the resonance frequency. Therefore, this configuration provides the effect of being able to suppress the vibration of the vibrating body VB at and near the resonance frequency, compared to the case in which the bracket is formed of stainless steel. The same applies to a case in which the bracket 11 is formed of aluminum, an alloy containing copper, an alloy containing aluminum, or the like.

As described above, the vibration generating device 101 according to an embodiment of the present disclosure includes, as illustrated in FIGS. 1 to 3, the housing HS, the movable body (the vibrating body VB) housed in the housing HS, the supporting member (the elastic supporting member ES) configured to support the movable body (the vibrating body VB) to be vibratable along the first direction (the X-axis direction), the coil 12 including the wire bundle extending along the second direction (the Y-axis direction) perpendicular to the first direction (the X-axis direction), and the magnetic flux generating member (the magnet 15) configured to generate a magnetic flux passing through the wire bundle along the third direction (the Z-axis direction) perpendicular to each of the first direction (the X-axis direction) and the second direction (the Y-axis direction). The vibration generating device 101 is configured such that one of the coil 12 or the magnetic flux generating member (the magnet 15) is fixed to the housing HS, and the other of the coil 12 or the magnetic flux generating member (the magnet 15) is fixed to the movable body (the vibrating body VB). Also, the vibration generating device 101 includes the conductive member (the bracket 11) that is fixed to the coil 12 and extends along the first direction (the X-axis direction) so as to cross the magnetic flux, and is configured to reduce the acceleration (the vibration acceleration) of the movable body (the vibrating body VB) by generating the eddy current in response to the movement of the movable body (the vibrating body VB) along the first direction (the X-axis direction).

With this configuration, the magnetic flux generating member (the magnet 15) and the conductive member (the bracket 11) can generate the braking force (the force to suppress the vibration) similar to a gel-like damper member configured to generate viscous resistance. Also, this configuration can suppress the resonance of the vibrating body VB by the braking force. In this configuration, the braking force is caused by the eddy current. Therefore, this configuration, not including a deformation portion or a sliding portion like a gel-like damper member, provides the effect of being able to increase durability of the vibration generating device 101.

In typical vibration generating devices, the braking force caused by the eddy current can be an undesirable force that reduces the vibration acceleration. However, the vibration generating device 101 according to the present disclosure is configured to suppress the resonance of the vibrating body VB by positively utilizing the braking force caused by the eddy current.

The conductive member (the bracket 11) may be formed of a non-magnetic metal. This configuration provides the effect of being able to prevent a magnetic force (an attractive force) from acting between the conductive member and the magnet 15 as in the case in which the conductive member (the bracket 11) is formed of a magnetic metal, and preventing such an attractive force from inhibiting efficient use of a driving force generated by the driver DM. In the illustrated example, the conductive member (the bracket 11) is formed of tough-pitch copper and housed in the housing HS formed of austenitic stainless steel having conductivity lower than the conductivity of the tough-pitch copper. This configuration provides the effect of being able to suppress flowing of the eddy current out of the housing HS.

The conductive member (the bracket 11) may be formed of a material having conductivity higher than conductivity of iron and an iron alloy. This configuration provides the effect of being able to increase the braking force caused by the eddy current (the force to suppress the vibration). This is because the higher the conductivity, the greater the braking force caused by the eddy current. Therefore, for example, this configuration provides the effect of being able to suppress the resonance of the vibrating body VB that is heavier.

Also, desirably, the conductive member (the bracket 11) may be formed of copper, aluminum, or an alloy thereof. This configuration provides the effect of being able to reduce the cost of a material compared to a case in which the conductive member is formed of a noble metal, such as silver or the like, or an alloy thereof.

Also, the conductive member (the bracket 11) may be provided between the magnetic flux generating member (the magnet 15) and the coil 12. Compared to a case in which the coil 12 is disposed between the conductive member (the bracket 11) and the magnetic flux generating member (the magnet 15), this configuration provides the effect of being able to increase the braking force (the force to suppress the vibration) because the conductive member (the bracket 11) can be disposed at a position closer to the magnetic flux generating member (the magnet 15). This is because the closer the conductive member (the bracket 11) is to the magnetic flux generating member (the magnet 15), the higher the density of magnetic fluxes passing through the conductive member (the bracket 11), and the higher the density of magnetic fluxes passing through the conductive member (the bracket 11), the greater the braking force.

Also, the vibration generating device 101 may include a magnetic flux attracting member configured to attract a magnetic flux to a position separated from the magnetic flux generating member (the magnet 15) along the third direction (the Z-axis direction). In this case, the conductive member (the bracket 11) may be disposed between the magnetic flux generating member (the magnet 15) and the magnetic flux attracting member. In the illustrated example, the magnet 15 functions as the magnetic flux generating member and the magnetic flux attracting member, and the yoke 10 functions as the magnetic flux attracting member. Specifically, when the upper magnet 15U functions as the magnetic flux generating member, the lower yoke 10D and the lower magnet 15D function as the magnetic flux attracting member. When the lower magnet 15D functions as the magnetic flux generating member, the upper yoke 10U and the upper magnet 15U function as the magnetic flux attracting member. One of the upper magnet 15U or the lower magnet 15D may be omitted. When the upper magnet 15U is omitted, the lower magnet 15D functions as the magnetic flux generating member, and the upper yoke 10U functions as the magnetic flux attracting member. The same applies to a case in which the lower magnet 15D is omitted. In this configuration, a substantially right angle is formed as an angle (hereinafter referred to as a “magnetic flux angle”) that is formed between an extending direction (the X-axis direction or the Y-axis direction) of the conductive member (the bracket 11) and the direction (the Z-axis direction) of the magnetic flux from the magnetic flux generating member (the magnet 15) toward the magnetic flux attracting member. Thus, this configuration provides the effect of being able to increase the braking force (the force to suppress the vibration) compared to a case in which the magnetic flux angle is not a right angle. This is because, when the magnetic flux density is the same, the braking force increases as the magnetic flux angle is closer to a right angle.

For example, the magnetic flux generating member may be the upper magnet 15U referred to as a first permanent magnet, and the magnetic flux attracting member may be the lower magnet 15D referred to as a second permanent magnet. In this case, as illustrated in FIG. 7, the first permanent magnet (the upper magnet 15U) and the second permanent magnet (the lower magnet 15D) may be disposed such that the surfaces facing each other have different polarities. This configuration can make the magnetic flux angle even closer to a right angle, and provides the effect of further increasing the braking force (the force to suppress the vibration).

Also, as illustrated in FIG. 4, the vibration generating device 101 may include the bracket 11 that includes: the plate-like portion 11B that extends along a plane parallel to each of the first direction (the X-axis direction) and the second direction (the Y-axis direction) and to which the coil 12 is to be attached; and the connecting portion 11A that is provided to extend from the plate-like portion 11B and is fixed to the housing HS. In this case, the coil 12 may be fixed to the housing HS (the base member 2) via the bracket 11, and the magnetic flux generating member (the magnet 15) may be fixed to the movable body (the vibrating body VB). The plate-like portion 11B may be formed of copper, aluminum, or an alloy thereof, and may be configured to function as the conductive member. This configuration provides the effect of being able to reduce the number of parts compared to a case in which a member other than the bracket 11 (the plate-like portion 11B) functions as the conductive member.

Also, the conductive member (the bracket 11) may be configured so as to include no opening at a position corresponding to the trajectory TR of the centers of the magnetic fluxes (see the upper view of FIG. 4) when the movable body (the vibrating body VB) vibrates. That is, the conductive member (the bracket 11) may be configured to always cross the magnetic flux at least in the center region CR when the movable body (the vibrating body VB) vibrates. This configuration provides the effect that the eddy current is more likely to flow than in a case in which an opening crossing the trajectory TR is formed.

Also, the coil 12 may include: the air-core portion AC, which is the innermost portion of the coil-wound portion; and the conductive wire CP, which extends outward of the air-core portion AC. The conductive member (the bracket 11) may have an opening for preventing interference with the conductive wire CP (see the first opening H1 in the upper view of FIG. 4) when the coil 12 is attached. In this case, the opening (the first opening H1) may be formed at a position that is not on the trajectory TR. That is, the opening (the first opening H1) may be formed at a position that is not in the center region CR. This configuration prevents interference between the conductive wire CP and the conductive member (the bracket 11), and provides the effect that the eddy current is more likely to flow than in a case in which the opening (the first opening H1) crossing the trajectory TR is formed.

The air-core portion AC may be formed in an elongated shape extending along the second direction (the Y-axis direction), as illustrated in the lower view of FIG. 4. In this case, as illustrated in the upper view of FIG. 4, the conductive wire CP may be formed so as to extend outward of the end of the air-core portion AC in the second direction (the Y-axis direction). In the example illustrated in the upper view of FIG. 4, the conductive wire CP is formed so as to extend forward (the X1 direction) of the right end (Y2-side end) of the air-core portion AC. This configuration provides the effect of being able to form the opening (the first opening) at a position away from the trajectory TR unlike in a case in which the conductive wire CP is formed so as to extend outward of a portion other than the end of the air-core portion AC (e.g., a center portion).

Also, as illustrated in FIG. 13, the vibration generating device 101 may be configured such that the acceleration (the value of vibration acceleration) upon the movable body (the vibrating body VB) vibrating at the resonance frequency is equal to or less than two times the acceleration (the value of vibration acceleration) upon the movable body (the vibrating body VB) vibrating at the frequency two times higher than the resonance frequency. This configuration provides the effect of being able to suppress vibration of the vibrating body VB at and near the resonance frequency.

The preferable embodiments of the present invention have been described above in detail. However, the present invention is not limited to the above-described embodiments. Various modifications, substitutions, and the like are applicable to the above-described embodiments without departing from the scope of the present invention. Each of the features described with reference to the above-described embodiments may be appropriately combined together unless there is a technical contradiction.

For example, in the above-described embodiments, the magnet 15 is a component of the vibrating body VB and the coil 12 is a component of the non-vibrating body NV, but the magnet 15 may be a component of the non-vibrating body NV and the coil 12 may be a component of the vibrating body VB. That is, the vibration generating device 101 may be configured such that the magnet 15 is fixed to the cover member 1 or the base member 2, and the bracket 11 and the coil 12 vibrate along with the yoke 10.

Also, in the above-described embodiments, the vibrating body VB includes the yoke 10 and the magnet 15, but the yoke 10 may be a component of the non-vibrating body NV. In this case, the yoke 10 may be fixed to the inner surface of the housing HS. Alternatively, in this case, the coil 12 may be fixed to the inner surface of the conductive member (the bracket 11), and the conductive member (the bracket 11) may be fixed to the inner surface of the yoke 10. That is, the coil 12 may be disposed between the vibrating body VB (the magnet 15) and the conductive member (the bracket 11), or may be disposed between the yoke 10 and the conductive member (the bracket 11).

Also, in the above-described embodiments, the magnet 15 includes the upper magnet 15U and the lower magnet 15D, but one of the upper magnet 15U or the lower magnet 15D may be omitted. For example, the lower magnet 15D may be omitted. In this case, the yoke 10 may be a component of the non-vibrating body NV. For example, the upper yoke 10U may be omitted, and the lower yoke 10D may be fixed to the base member 2. Alternatively, in this case, the conductive member, such as the bracket 11 or the like, may be disposed on the opposite side of the upper magnet 15U via the coil 12 and fixed to the base member 2 or the lower yoke 10D.

The conductive member (the bracket 11) may be a cylindrical member. In this case, the coil 12 may be wound around a cylindrical conductive member. The magnet 15 may be configured to vibrate, inside the cylindrical conductive member, in an axial direction of the cylindrical conductive member. In this configuration, the coil 12 wound around the outer circumferential surface of the cylindrical conductive member may be fixed to the inner circumferential surface of the cylindrical yoke 10 disposed outside the coil 12. The outer circumferential surface of the cylindrical yoke 10 may be fixed to the housing HS disposed outside the cylindrical yoke 10.

Also, the bracket 11 may be configured by a base formed of a non-conductive member and a conductive member (conductive film) attached to the base. In this case, the conductive film may be, for example, a film formed of copper, aluminum, or an alloy thereof.

In the above-described embodiments, the vibration generating device 101 is configured to include the magnet 15 magnetized with 8 poles and the coil 12 including three coil-wound portions (six wire bundles). However, the vibration generating device 101 may be configured to include: the magnet 15 magnetized with the number of magnetic poles other than 8 poles, such as 2 poles, 4 poles, 6 poles, 10 poles, 12 poles, or the like; and the coil 12 having a corresponding number of wire bundles. That is, the coil 12 may be configured to include one, two, or four or more coil-wound portions.

The above-described configuration provides a more durable vibration generating device.

What is claimed is:

1. A vibration generating device, comprising:
a housing;
a movable body housed in the housing;
a supporting member configured to support the movable body to be vibratable along a first direction;
a coil including a wire bundle that extends along a second direction perpendicular to the first direction; and
a magnetic flux generating member configured to generate a magnetic flux that passes through the wire bundle along a third direction perpendicular to each of the first direction and the second direction, wherein
one of the coil or the magnetic flux generating member is fixed to the housing,
another of the coil or the magnetic flux generating member is fixed to the movable body, and
the vibration generating device includes a conductive member that is fixed to the coil and extends along the first direction so as to cross the magnetic flux, and is configured to reduce an acceleration of the movable body by generating an eddy current in response to a movement of the movable body along the first direction.

2. The vibration generating device as claimed in claim 1, wherein
the conductive member is formed of a non-magnetic metal.

3. The vibration generating device as claimed in claim 1, wherein
the conductive member has conductivity higher than conductivity of iron and an iron alloy.

4. The vibration generating device as claimed in claim 1, wherein
the conductive member is formed of copper, aluminum, an alloy containing copper, or an alloy containing aluminum.

5. The vibration generating device as claimed in claim 1, wherein
the conductive member is disposed between the magnetic flux generating member and the coil.

6. The vibration generating device as claimed in claim 1, wherein
the vibration generating device further includes a magnetic flux attracting member configured to attract the magnetic flux to a position separated from the magnetic flux generating member along the third direction, and
the conductive member is disposed between the magnetic flux generating member and the magnetic flux attracting member.

7. The vibration generating device as claimed in claim 6, wherein
the magnetic flux generating member is a first permanent magnet,
the magnetic flux attracting member is a second permanent magnet, and
the first permanent magnet and the second permanent magnet are disposed such that surfaces facing each other have different polarities.

8. The vibration generating device as claimed in claim 1, wherein
the vibration generating device includes a bracket that includes
a plate-like portion that extends along a plane parallel to each of the first direction and the second direction and to which the coil is to be attached, and
a connecting portion that is provided to extend from the plate-like portion and is fixed to the housing,
the coil is fixed to the housing via the bracket,
the magnetic flux generating member is fixed to the movable body, and
the plate-like portion is formed of copper, aluminum, an alloy containing copper, or an alloy containing aluminum, and functions as the conductive member.

9. The vibration generating device as claimed in claim 1, wherein
the conductive member includes no opening at a position corresponding to a trajectory of a center of the magnetic flux that is formed in response to vibration of the movable body.

10. The vibration generating device as claimed in claim 9, wherein
the coil includes an air-core portion, and a conductive wire extending outward of the air-core portion,
the conductive member includes an opening for preventing interference with the conductive wire upon attachment of the coil, and
the opening is formed at a position that is not on the trajectory.

11. The vibration generating device as claimed in claim 10, wherein
the air-core portion is formed in an elongated shape extending along the second direction, and
the conductive wire is formed so as to extend outward of an end of the air-core portion in the second direction.

12. The vibration generating device as claimed in claim 1, wherein
an acceleration upon the movable body being driven at a resonance frequency is equal to or less than two times an acceleration upon the movable body being driven at a frequency two times higher than the resonance frequency.
